(19) United States
(12) Patent Application Publication
(10) Pub. No.: US 2006/0068840 A1
(43) Pub. Date: Mar. 30, 2006

(54) Event transportation system and method

(76) Inventor: Frank Sherman, Sandy Spring, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/220,919

(22) Filed: Sep. 8, 2005

Related U.S. Application Data
(60) Provisional application No. 60/607,592, filed on Sep. 8, 2004.

(51) Int. Cl. H04M 1/00

(52) U.S. Cl. 455/552.1; 455/556.1

(57) ABSTRACT

An event guide system to coordinate passenger transport and to provide event information including a transport vehicle, a host processor, and a portable processor remote from the host processor. The vehicle includes a processor capable of receiving event information and video data from the portable processor, as well as transmitting vehicle status data to the portable processor. The portable processor is capable of receiving the vehicle status data fro the vehicle processor, as well as transmitting the vehicle status data to the host processor. The host site operable to receive and store the vehicle status data.

### CROSS REFERENCE TO RELATED APPLICATIONS

This application claims priority to U.S. Provisional Application 60/607,592 filed Sep. 8, 2004 and entitled “Event Transportation System and Method”, incorporated herein by reference in its entirety.

### FIELD OF THE INVENTION

The present invention pertains to an event guide system in which buses or other people carriers communicate with mobile information kiosks via a distributed wireless network to permit display on the buses of timely event information and sponsor messages.

### BACKGROUND OF THE INVENTION

Managing the complex transportation requirements associated with major events is a challenging endeavor involving a myriad of tasks, including directing and moving the attendees via shuttle bus operations. This typically entails large fleets of motor coaches or other similar vehicles and teams of staff to direct the operation. This service is very costly to event organizers and provides a significant challenge in both managing the fleet for effective service, as well as providing accurate and timely information to the attendees in transit to or from the event.

In addition, there is no simple way to entertain attendees during long rides to/from meetings or to inform them of critical or logistical information necessary related to the event. It is particularly difficult to provide such information in a cost effective manner. Although many coaches are now equipped with video systems, they typically only accommodate a single media type (e.g. DVD, VHS), and are typically static systems that cannot be updated easily. This limits the ability of event organizers to easily provide information, entertainment, and advertisements that might reduce attendee frustration, as well as effectively reduce the transportation expense.

### OBJECTS AND SUMMARY

Accordingly, it is an object of the present invention to provide an event guide system in which vehicles (e.g., people carriers such as buses) communicate with a mobile information kiosk via a wireless network to permit the display of information within the buses.

The aforesaid objects are achieved individually and/or in combination, and it is not intended that the present invention be construed as requiring two or more of the objects to be combined unless expressly required by the claims attached hereto.

According to the present invention, an event guide system includes a host site, portable sites, and a vehicle (or a fleet of vehicles) adapted to transmit information to and receive information from the host site and the portable sites. The vehicle is equipped a GPS device, a WLAN device, and/or a GPRS/GSM device. The GPS device determines the location of the vehicle, and transmits the location information over a GPRS network to the host site. The host site includes a computer system operable to receive, sort, and store the vehicle location information, and forward vehicle location information to a communication device such as a video display. The computer system further forwards (via the wireless network) event-specific and/or vehicle specific data to the portable sites. Each portable sites, moreover, may be configured to identify a vehicle in proximity to the portable site, and transfer the data to the vehicle. Conversely, the vehicle includes a computer system operable to regulate, store, and forward vehicle data to the portable sites. Vehicle data include software upgrades, as well as information pertaining to the particular event (meeting times and places, social outings, etc.). The data may be displayed on video displays positioned throughout the vehicle. The vehicle may further include sensors that monitor passengers entering and exiting the vehicle, as well as an identification sensor operable to identify a passenger on board the vehicle. The computer system is further configured to process and forward vehicle-specific data (passenger load, operating status, etc.) to the host site. With this configuration, event-specific, vehicle-specific, and passenger-specific content may be provided to event attendees in real time, and the transport of the attendees may be coordinated via the host and portable sites.

The above and still further objects, features, and advantages of the present invention will become apparent upon consideration of the following detailed description of a specific embodiment thereof, particularly when taken in conjunction with the accompanying drawings wherein like reference numerals in the various figures are utilized to designate like components.

### BRIEF DESCRIPTION OF THE DRAWINGS

FIG. 1 is a functional diagram of an event transportation system according to an embodiment of the present invention.

FIG. 2 is illustrates a schematic diagram of the audio/video system within an event transport vehicle.

FIG. 3 is a functional diagram of an event transportation system according to another embodiment of the present invention.

FIG. 4 is a functional diagram of an event transportation system according to still another embodiment of the present invention.

### DETAILED DESCRIPTION OF THE PREFERRED EMBODIMENTS

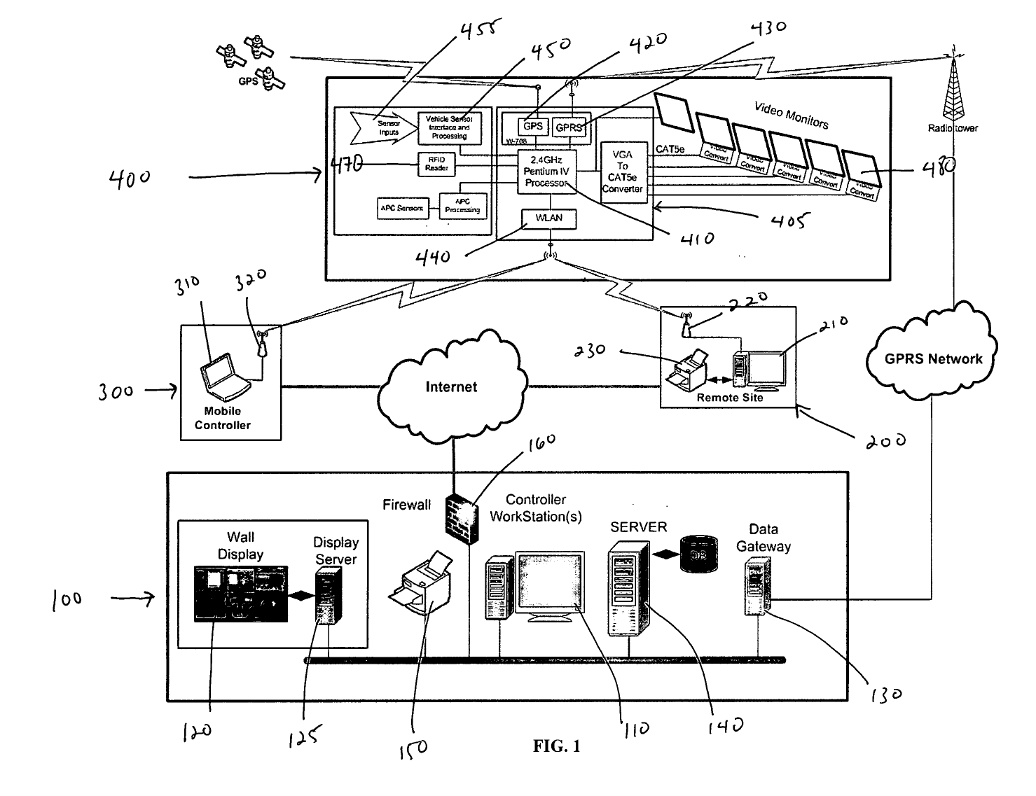

FIG. 1 illustrates an exemplary system for managing transport vehicles during an event. As shown, the system 10 includes (1) a host site 100 (also called a service provider site); (2) portable sites including a remote site 200 and a mobile site 300; and (3) at least one vehicle 400. The host site 100 is in communication with at least one of the remote site 200, the mobile site 300, and the vehicle 400. Although not shown in FIG. 1, the system typically includes a plurality of remote sites 200, a plurality of mobile sites 300, and a plurality of vehicles 400, each in communication with a single host site 400. By way of example, the system 10 may simultaneously operate a fleet of 200 vehicles 100, three remote sites 200, and five mobile sites 300. It should be understood, however, that any number of vehicles 100, remote sites 200, or mobile sites 300 within the communication capabilities of host site 400 may be utilized.

The host site 100 is essentially the focal point that receives information from a vehicle, transmits information to a vehicle, and processes, stores, forwards, and displays the information to the appropriate remote site 200, mobile site 300 and vehicle 400 to enable vehicle tracking and event coordination (information dissemination, etc.). The host site 100 may include a host computer system 110 configured to track each vehicle 400, monitor vehicle conditions, and transmit event data to each vehicle. The host computer system 110 further receives, analyzes, and reports historical performance data for each vehicle. The host site 100 may also include a host display 120 (with a corresponding display server 125) in communication with the host computer system 110 for displaying event and/or vehicle information, as well as for viewing a single-venue or multiple-venue (e.g., two to six) Computer Aided Dispatching and Automatic Vehicle Location (CAD/AVL) windows. The host display 120 may include, but is not limited to 21″ TFT flat panel displays. The host site 100 also includes a communications interface 130 connected to a general packet radio service (GPRS) network for the communication of data messages to/from the vehicle 400. Furthermore, the host site 100 may include a host server 140 operable to collect and distribute operational data of the vehicle 400 and to provide data access for processors located at the remote site 200 and the mobile site 300 (discussed in greater detail below). The host computer system 110 may further include a printer 150 to generate hard copy displays of information, as well as to generate reports. Each of the display/server 120/125, communications interface 130, the main server 140, and the printer 150 communicate with each other, the remote site 200, and mobile site 300 via the internet or other communications systems (wireless, phone lines, fiber optic, etc.). The host site 100 may further include a gateway 160 that limits access between networks in accordance with a predetermined security policy (i.e., a firewall).

The host computer system 110 is adapted to transmit operational data to the vehicle 400. Specifically, the host server 140 is the control center for the distribution and collection of all versions of executable vehicle software and operational data, as well as the storage area for the vehicle performance data base. In operation, the host server 140 transfers the latest version of updated vehicle software or operational data to the remote site 200 and/or to the mobile site 300. The host server 140 may also maintain a log of the latest version of files loaded at the remote site 200, the mobile site 300, and onto each vehicle 400. With this configuration, the system is capable of providing fleet operational data preparation and management capability.

The remote site 200 is a portable site that includes a remote workstation (also called a remote computer system) 210 configured to manage the vehicle 400 in real-time and to view, analyze, and report historical performance data of the vehicle 400. The remote workstation 210 includes a processor that communicates with the host site (i.e., the host server 440) through an internet connection (wireless, broadband, dial-up, fiber optic, etc.) to access data. For example, the remote computer system may comprise a stand-alone device such as a kiosk with a display screen operable to display information as designated by the host site. The location of the remote site 200 is not limited. Typically, the remote site is located within a venue (i.e., an area remote from the host site 100), near the location of a particular event. The remote site 200, moreover, is positioned within the operational area of a vehicle fleet. For example, the remote computer system 210 may reside at the garages and depots from which the vehicles depart, are maintained, or are stored. The remote computer system 210 includes a wireless local area network (WLAN) device to enable communication with the vehicle 400 (i.e., the vehicle computer system 410). The type of WLAN network includes, but is not limited to, an IEEE 802.11g that supports bulk data transfer. The remote computer system 210 may further include a printer to generate a hard copy of operational data or other informational reports.

The mobile site 300 includes sites in the fleet operational area as determined by the host provider. For example, a mobile site 300 may be located a host facility or any other host-specified location. The mobile site 300 includes a mobile workstation or computer system 310. For example, the mobile workstation 310 may include a WLAN equipped laptop computer. Similar to the remote computer system 210, the mobile computer system 310 is a portable system capable of managing each vehicle 400 in real-time, as well as viewing, analyzing, and reporting the historical performance data of each vehicle 400. The mobile computer system 310 includes a processor that communicates with the host site (i.e., the host server 140) through an internet connection (broadband, dial-up, fiber optic, etc.) to access data and to upload data files and transfer them to directly to the host server 140 for storage and archival. By way of specific example, the mobile site 300 may comprise a WLAN device in communication with a WLAN network such as an IEEE 802.11g to supports bulk data transfer.

As discussed above, the host computer system 110 is capable of transmitting the latest versions of vehicle executable software to the vehicles, as well as receiving operational data files and downloads from the vehicles via the portable computer systems 210, 310 and, in particular, the WLAN connections. The host computer system 110 maintains a log of the versions of software and operational data files on each of the vehicles in the operational area of the portable computer systems 210, 310. Each vehicle 400, moreover, includes an on-board computer system and a WLAN device (discussed in greater detail below). In operation, when a vehicle 400 comes within range of a portable site 200, 300 the vehicle on-board computer system establishes a link with the portable computer system 210, 310 verifying whether or not the vehicle has the latest version of files on-board. If the vehicle does not have the latest version of the files, the portable computer system 210, 310 initiates a process to update the appropriate file(s). Files include not only operational software (map information, venue information, and other system updates), but also information to be displayed on screens located in a particular vehicle 400 (event information (meeting times, speaker information, etc.) and venue information (local hotels, restaurants, etc.) Each portable computer system 210, 310 maintains a communications log for each vehicle 400. This log may include data such as vehicle ID, date and time of communication, files transferred, etc. The remote site computer system 210, moreover, is capable of generating a report displaying this information.

In operation, data files can be downloaded from the host site 100 to each vehicle 400 by first transferring the data to the remote site computer system 210 through the internet. When a vehicle 400 travels within range of the remote site 200, data is transferred to the vehicle via the WLAN network (i.e., via the WLAN device 220 located at the remote site 200). Conversely, data files can be uploaded from each vehicle 400 by first transferring the data to the remote site computer system 210 (via WLAN device 220) and then transferring the data to the host site 100 via the internet. The data is then transferred to the host server 140 for storage and archival.

Similarly, the data files can be downloaded to a vehicle 400 via the mobile sites 300. The data files will first be transferred to the mobile computer system 310 (i.e., the laptops including the GPS device 320) via the internet. Then, when a vehicle 400 comes within range, the data can be transferred to the vehicle via the WLAN network. In this manner, event-specific, vehicle-specific, and venue-specific information can be continually transmitted from the host site 100 to each vehicle 400, and vice versa.

The transport vehicle or people carrier 400 is configured to transport a group of passengers to various destinations within a venue or during the event. For example, the vehicle may comprise a car, a limousine, a shuttle, a school bus, or a cross-country bus. In the embodiment illustrated in FIGS. 1-3, the vehicle 400 comprises a bus. The bus may accommodate, for example, 45 seated passengers and 20 standing passengers. The vehicle 400 includes and on-board computer system 405 configured to receive, process, and store passenger and bus information, as well as generate audio and video output. Referring specifically to FIG. 1, the vehicle includes an on-board computer system 405 with vehicle processor 410, a global positioning system (GPS) transmitter/receiver 420, a general packet radio service (GPRS)/global system for mobile communications (GSM) transmitter/receiver 430, and a wireless local area network (WLAN) transmitter/receiver 440. The on-board system may further include a vehicle sensor processor 450, mechanical sensors 455, a passenger counting processor 460, and a radio frequency identification (RFID) reader 470

The on-board computer system 405 communicates with the host site 100, the remote site 200, and the mobile site 300. Specifically, it transmits and receives data from the host site 100 over a GPRS network (via the GPRS/GSM device 430). Information transmitted includes location data obtained via the GPS device 420, as well as vehicle status information (discussed in greater detail below). The GPRS network may be a commercially available GPRS data communications provided by standard telecommunications companies. The network will typically support GSM voice communications, and be operable in the 1900 MHz U.S. band for GSM/GPRS communications.

The on-board computer system 405 is configured to provide GPS derived location (e.g., latitude/longitude) and transfer this data to the host site at predetermined intervals (e.g., one-second intervals) via a serial communications port. The processor 410 provides this vehicle location to the host site 100 via the GPRS data network at the fixed reporting intervals, or on a one-time poll basis. In operation, when the predetermined vehicle reporting interval passes, each active vehicle in operation may be independently or collectively polled. When polled, each vehicle 400 reports its status via the GPRS data system, transmitting a vehicle status message to the host server 140. The standard vehicle status message may include, but is not limited to vehicle ID, date and time, vehicle location, vehicle speed, and sensor status data. In this manner, all vehicles 400 active during an event can be monitored by the host site 100.

As discussed above, the event guide system 10 further supports bulk data transfer to the vehicle 400. Each on-board system includes a WLAN device 140 for receiving (downloading) executable vehicle software and transmitting (uploading) vehicle operational data files (schedule data, route data, parameter data, etc). The WLAN connection is particularly useful in downloading audio and video information relating to a given event, the venue in which the event is located, or detailed information about meetings, speakers, attendees, etc.

The vehicle 400 also includes a sensor processor 450 that operates several onboard sensors 455 to monitor various vehicle parameters. Specifically, sensor processor 450 communicates with the sensors 455, which are located throughout the vehicle 400. Each sensor is provided with a preset threshold value-when the value is exceeded, the appropriate sensor generates a signal (e.g., an event message) and sends it to the sensor processor 440, which, in turn, transmits the information to the vehicle processor 410 and, ultimately, to the information the host site 400 via the WLAN network when the vehicle comes within range of the remote site 200 or the mobile site 300. With this configuration, an operator at the host site 100 can monitor vehicle parameters such as engine temperature, oil pressure, air pressure, battery charge, etc.

The vehicle also includes an automatic passenger counting (APC) processor 460 operatively connected to sensors positioned above each vehicle entrance. The sensors (e.g., optical direction sensors) are configured to identify a passenger entering or leaving the vehicle 400. This information is processed by the APC processor 460, tracking not only passengers entering and exiting the vehicle 400 at each stop, but also tracking and maintaining a record of the overall passenger load for each vehicle 400. Exemplary automatic passenger counting systems are available from InfoDev USA (Las Vegas, Nev.).

In operation, when the vehicle doors open, the door sensors are activated. The sensor identifies the number of passengers entering and/or leaving the vehicle 400 at a particular site, and communicates the information to the vehicle processor 410. The vehicle processor 410 maintains an on-board log of the entering and exiting passengers, as well as correlates passenger load with each stop along with other relevant data such as: the name of the stop, the geographic position (latitude and longitude) of the stop, the time of day, the name of the route, the driver ID, etc. The vehicle processor 410, in turn, may report the passenger load information along with each status message. Specifically, the APC may then be uploaded to the host main server 440 via the WLAN network when the vehicle comes within range of the remote site 200 or the mobile site 300. Alternatively, it may be sent via the GPRS network.

The vehicle may further identify the number of passengers, or the presence of specific passengers, via the RFID reader 470. The reader may comprise a short range device capable of reading an RFID tag at distances of up to one meter. Event attendees may be provided with a smart tag (e.g., an RFID tag) that transmits RFID data (passenger information such as name, company, etc.) to the RFID reader 470. For example, the smart tag may be provided with RFID data that is 128-256 bytes in length. The RFID reader 470 detects and recognizes the passenger ID. The data read from the RFID reader 470 can be stored on the vehicle processor 410, and uploaded to the host processor 140 via the WLAN network when the vehicle comes within range of a remote site 200 or a mobile site 300.

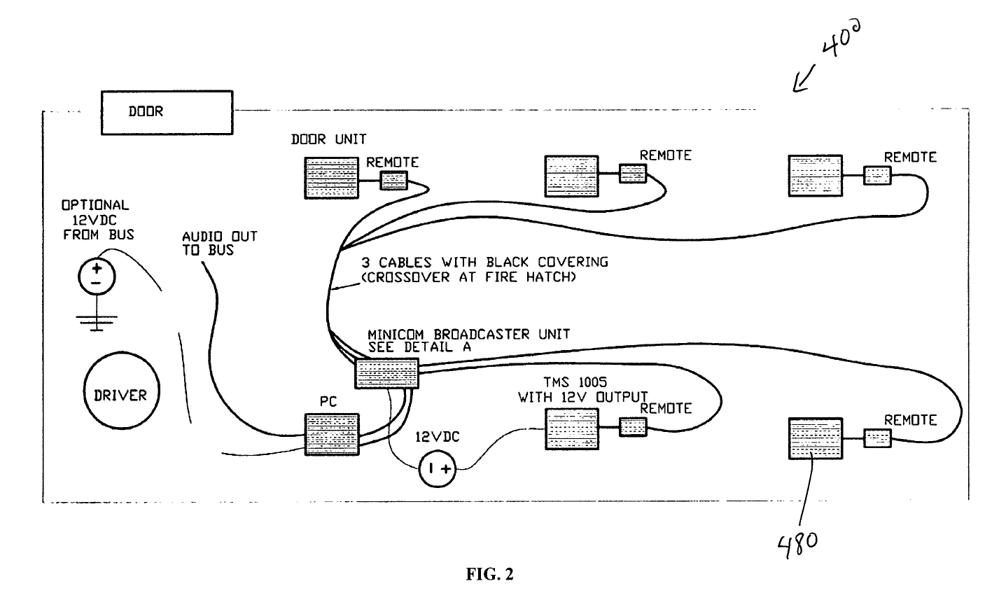

As shown in FIG. 1, the vehicle 400 may also be equipped with one or more video monitors 480 that receive audio/video data from the vehicle processor 410. The type of monitors is not limited, and includes plasma, LCD, and TFT capable of displaying a video graphics array (VGA), or capable of displaying signals provided via enhanced category 5 (CAT5e) connections. To accommodate varying connections and signals, a converter such as a VGA to CAT5e converter may be connected between the vehicle processor 410 and the video monitors 445. A schematic diagram of the audio/video system is illustrated in FIG. 2. In operation, the video data is transmitted by the host site 100 to the vehicle 400 through the WLAN network (via the remote 200 and mobile 300 sites). The vehicle processor transfers the signals to the monitors 480, which generates video and or audio output. Since the vehicles 400 of an event fleet are regularly connecting to the ELAN network via the remote sites 200 and the mobile sites 300, passengers on board the vehicle may have real time, up to date information regarding the venue (traffic, weather, etc.), event conditions (meeting time changes, cancellations, etc.), and vehicle parameters (future stops, approximate time to next and subsequent stops, etc.).

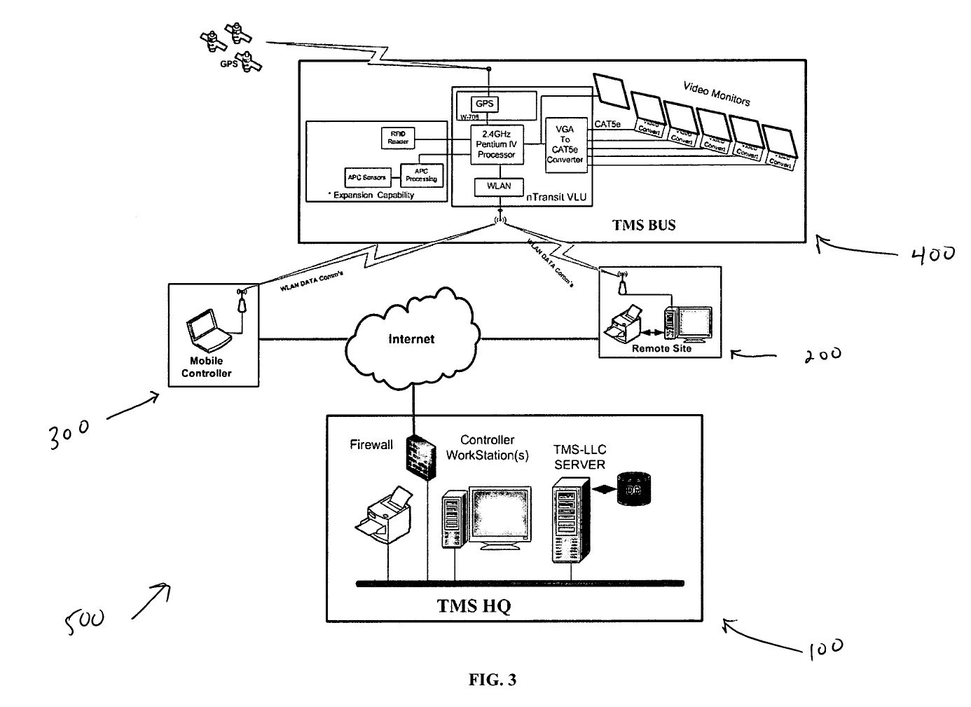

Another embodiment of the event guide system is illustrated in FIG. 3. In this embodiment, the system 500 comprises many of the same components as the system 10 described above, except the GPRS device from the vehicle 400 and the communications interface from the host site 100 are omitted. This embodiment is particularly useful when GPRS functionality is not desired.

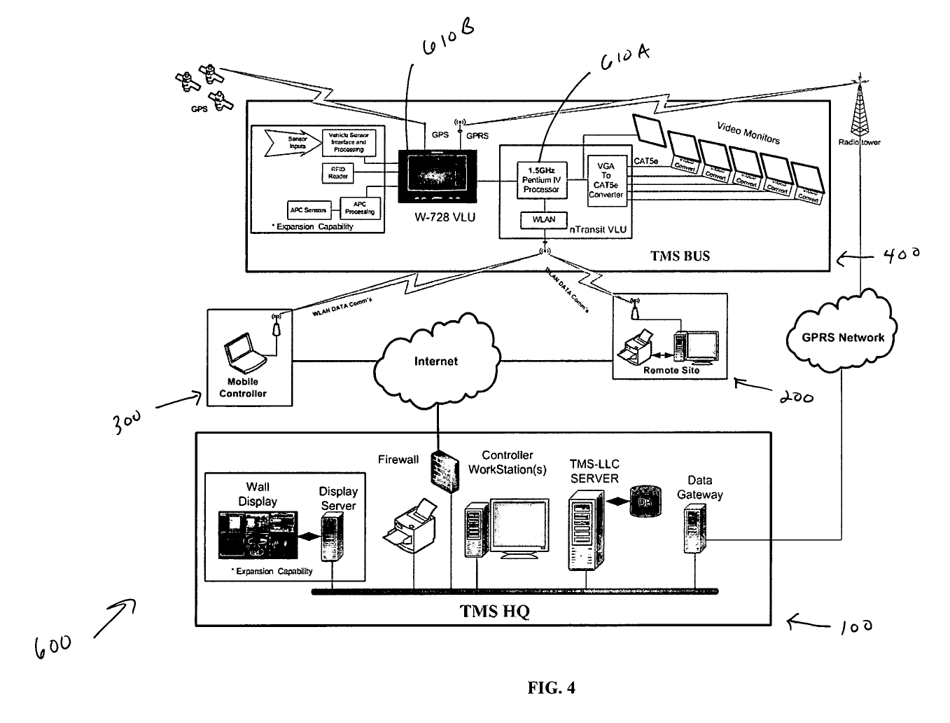

Still another embodiment of the invention is illustrated in FIG. 4. In this embodiment, the system 600 comprises many of the same components described in the system 10 above, but the vehicle includes two vehicle processors-one dedicated to drive video displays 610A and one dedicated to for fleet management functions 610B.

The above described system 10 provides is a technology-enabled transportation system for event organizers. Within this system a bus or other people carrier connects from node to node along a distributed wireless network as it displays timely event information and sponsor messages from displays mounted throughout the bus. Each display is connected to the on-board computer with a synchronized, multi-display adapter. The system provides a self-running event guide using Macromedia Flash technology, or the like, custom-generated from a wireless feed from the portable sites 200, 300 (e.g., a mobile information kiosk). Using rider-counting technology, the bus can also communicates rider and route information via the sideband of the cellular network, or over a wireless Internet connection, back to the kiosk which calculates and displays real time arrival and departure estimates for stops along each route, as well as recommends routing changes to transportation supervisors based on rider loading patterns. Using the synchronized, real-time network and GPS technology, the electronic event guide on board or displayed on the mobile information kiosk can be instantly customized to display a list of upcoming stops and related information and advertisements from event participants and/or area businesses. Furthermore, this information may be customized by other factors, such as events occurring that day, the weather report, or time of day. All buses or other transportation vehicles used in support of the event may display the same information, or they may display unique elements which can be combined dynamically by the system providing the rider the ability to remain informed while in transit to their destination.

It will be appreciated that the embodiments described above and illustrated in the drawings represent only a few of the many way of implementing the event guide system of the present invention. For example, the host 110, remote 210, mobile 310, and vehicle 405 computer systems, though preferably implemented by conventional personal computers, can be larger capacity computers when the data processing requirements necessitate increased processing power. Specifically, a computer system 110, 210, 301, 405 may include a conventional IBM-compatible, APPLE-compatible, or other type personal computer optionally equipped with one or more of a monitor, a base (i.e., including the processor, memory, and internal or external communication devices, ports or modems), a keyboard, and/or a mouse. The computer systems may include the appropriate software to perform data processing, uploading, and/or downloading for any of the host 110, remote 210, or vehicle 405 systems, depending upon the particular utilization of the computer system (i.e., whether the computer system is implemented as a host, remote, mobile or vehicle system). The computer systems may utilize any of the major platforms or operating systems such as WINDOWS, MACINTOSH, UNIX, DOS, or OS2. The software for the present invention may be implemented in any of a number of computer programming languages. It is to be understood that one of ordinary skill in the computer arts can develop the software based on the foregoing description and flow charts.

From the foregoing description it will be appreciated that invention makes available a novel method and system for facilitating an event transportation and guidance. Having described preferred embodiments of a new and improved method and system, it is believed that other modifications, variations, and changes will be suggested to those skilled in the art in view of the teachings set forth herein. It is therefore to be understood that all such variations, modifications, and changes are believed to fall within the scope of the present invention as defined in the appended claims.

We claim:

1. An event guide and transportation system comprising:
a host processor disposed at a host site operable to receive and store vehicle status data, and to transmit operational data and visual data;
a remote processor disposed at an event site remote from the host site operable to transmit the operational and visual data to a vehicle processor, wherein the remote processor is further operable to receive vehicle status data from the vehicle processor and transmit the vehicle status data to the host processor; and
a vehicle processor disposed in a mobile transport vehicle, wherein the vehicle processor is adapted to receive operational data and visual data, and is further capable of transmitting vehicle status data.

2. The event guide and transportation system of claim 1, wherein the mobile transport vehicle includes a video monitor operable to display the visual data;

3. A method of managing a plurality of vehicles at an event including the steps of
(a) transmitting operational data from a host processor to a remote processor;
(b) transmitting the operational data from the remote processor to a vehicle processor;
(c) transmitting vehicle status data from the vehicle processor to the remote processor; and
(d) transmitting the vehicle status data from the remote processor to the host processor.

4. The method of managing a plurality of vehicles of claim 3, wherein step (a) further comprises transmitting visual data to the remote processor, and step (b) further comprises transmitting the visual data to the vehicle processor.
